(19) United States
(12) Patent Application Publication
(10) Pub. No.: US 2008/0162690 A1
(43) Pub. Date: Jul. 3, 2008

(54) Application Management System

(75) Inventor: Vasilios Karagounis, Roselands (AU)

Correspondence Address: THE WEBB LAW FIRM, P.C., 700 KOPPERS BUILDING, 436 SEVENTH AVENUE, PITTSBURGH, PA, 15219, US

(73) Assignee: OBSERVVA TECHNOLOGIES PTY LTD, Roselands (AU)

(21) Appl. No.: 11/959,957

(22) Filed: Dec. 19, 2007

(30) Foreign Application Priority Data
Dec. 21, 2006 (AU) 2006907146

(51) Int. Cl. G06F 15/173

(52) U.S. Cl. 709/224

(57) ABSTRACT

An application management system 300 including a network tracking component 310 for obtaining network data 355, 360, an application translator 315, where the application translator 315 receives at least part of the network data 355, 360, and the application translator 315 analyzes the received network data and returns analyzed data to be sent to a data store 305. The system 300 detects distributed applications, services, databases, etc. through network interactions and monitors and/or analyzes network traffic to provide statistical information and/or check response times. The application translator 315 is one of multiple application translators selected based on a determination of the type of network data transfer.

### TECHNICAL FIELD

The present invention generally relates to the management of computer systems or software, and more particularly to the management of distributed systems, applications, services, programs and/or databases through reconstruction or monitoring of network interactions between systems, applications, services, programs and/or databases.

### BACKGROUND ART

Network management has become crucial to companies and other organisations providing services over a network such as, for example, the Internet or a Wide Area Network (WAN). Management systems have been developed for managing communication networks and various network applications or other elements.

The satisfactory management of networked systems, applications, services, programs or databases, especially custom applications, is presently very difficult to achieve. Current enterprise software management products require a significant amount of configuration by system administrators to monitor the critical components of a custom system. Performance and availability management products often require that components of the management software itself are physically installed on the same computers that are running the applications, thereby consuming resources on production computers.

There is a need for a method, system and/or computer program product which addresses or at least ameliorates one or more problems inherent in the prior art.

The reference in this specification to any prior publication (or information derived from the prior publication), or to any matter which is known, is not, and should not be taken as an acknowledgment or admission or any form of suggestion that the prior publication (or information derived from the prior publication) or known matter forms part of the common general knowledge in the field of endeavour to which this specification relates.

### DISCLOSURE OF INVENTION

According to a first aspect, there is provided an application management system, including: a network tracking component for obtaining network data; an application translator, the application translator receiving at least part of the network data, the application translator analyzing the received network data and returning analyzed data; and, a data store for storing the analyzed data.

According to a second aspect, there is provided a method of managing one or more applications, including the steps of: obtaining network data using a network tracking component; receiving at least part of the network data at an application translator; analyzing the received network data and the application translator returning analyzed data; and, storing the analyzed data in a data store.

According to a third aspect, there is provided an computer program product for managing one or more applications, including: a network tracking component for obtaining network data; an application translator, the application translator receiving at least part of the network data, the application translator analyzing the received network data and returning analyzed data; and, a data store for storing the analyzed data.

According to a fourth aspect, there is provided an application management system, the application management system installed on at least one processing system and including a tracking unit for monitoring network data received by the at least one processing system, the network data being transmitted between one or more applications, the tracking unit including at least one translator that is called based on a type of data transfer between the one or more applications, wherein the at least one translator analyzes the network data.

An application should be generally read as a reference to a Web service, program, database, component, tool, system or the like.

Preferably, more than one application translator is provided and the application translator is selected from the more than one application translator by the network tracking component.

In other particular, but non-limiting, forms: the application translator is selected based on a connection instance; the selected application translator is retained or not based on the type of further obtained network data; the application translator receives the at least part of the network data in a different format to the network data obtained by the network tracking component; the different format is generated by a filter component of the application management system; and/or, the network data is data transmitted between components of at least one distributed application.

Preferably, the application management system is not installed on the same processing system as an application.

Optionally, but not necessarily: the network data is data transmitted between two or more distributed applications; the application management system detects network-based applications, services or databases by analyzing the received network data; and/or, the application management system is associated with at least one network as an inline configuration or as a bus configuration.

In accordance with specific optional embodiments, provided by way of example only: the network data is TCP/IP data; the network data is received as a pre-formatted file; there is one instance of the network tracking component for each network interface; and/or, the data store also stores the obtained network data.

In accordance with further specific optional embodiments, provided by way of example only: a proactive management component is provided to receive and forward an application request from a remote terminal; a management component is provided and able to communicate with the data store to analyze data stored in data store; and/or the management component issues an alert if a preset threshold is exceeded.

An advantage of the Application Management System (AMS) is that the AMS is unobtrusive and not dependent on any specific platform or technology implementation. This is due to the fact that there are well established standards for the way applications communicate over a network. Another advantage is an ability to compose and extend the applications, software and systems being managed. The AMS allows the addressing of new standards and implementations in application software and packaged software.

Embodiments of the AMS can provide the following significant features or advantages:

(i) Unobtrusive: The AMS can provide detailed management and optimisation information about systems without the need for reconfiguration, addition of software or other environmental changes to those systems. Examples of information that the AMS produces include statistics of web applications, database response times, request rates of physical servers, concurrent users of a system, a list of servers doing redundant work which (at low request rates) can afford instances of the server shutdown to conserve power, etc. These statistics may be monitored to check compliance with an end to end Service Level Agreement (SLA). An SLA may be a contractually “agreed to” response time for an electronic business transaction. SLAs on business systems usually have a financial impact if the system breaches them. Due to the nature of independent implementation of the AMS as a device on a network, the AMS need not place software or configuration dependencies on production servers and does not require revision of production servers when new systems are placed on a network or new applications are deployed on a network. This provides the ability for continued discovery of new applications and also the ability to deploy new applications without having to independently configure and manage these applications.

(ii) Speed of analysis/findings: Given the unobtrusive approach and design, the AMS can bring value from a management and analysis standpoint very quickly to an implementation. The AMS can start providing management statistics of applications or systems relatively quickly, for example within minutes, of being installed.

(iii) A safe approach: Managers of large systems are always vigilant against changes to critical business applications. In many instances, a change that has an unintended affect can cause system instability or failure. Therefore, system managers generally insist on significant testing on changes that can affect critical applications. The AMS has been designed to not require changing or reconfiguring applications. This removes many of the barriers to adoption for system managers and is a significant differentiator of the AMS when compared with prior art management systems.

(iv) A usage-based charging model: By being able to “discover” applications and services on a network, the AMS inherently promotes a charging model based on the number of services and applications monitored (a usage-based charging model) rather than charging a fixed fee for the AMS. From a business standpoint this makes it easier for corporations to tailor their expenditure based on need and actual usage rather than an estimated cost model with high initial expenditure amortised over several years.

(v) Detection: The AMS can detect distributed applications, services, databases, etc., through reconstruction of network interactions between systems. The AMS can also discover their constituent parts in terms of the nodes that are involved in the web services interactions and the messages being sent between nodes.

(vi) Productivity for administrators: The AMS is able to make the administration and discovery of new systems highly automated and easy to administer. The AMS can discover applications and then offer a selection of the applications for advanced management. For example, once a new service is discovered, an option can be offered to an administrator to assign an SLA alert to the service, rather than the traditional method of requiring the administrator to add complicated information into a management system describing the service.

(vii) Conserving power: The AMS can detect physical servers which are replicas running the same application, based on the specific requests over the specific protocols (or through administrator instruction). By detecting the fact that multiple physical servers at runtime are serving the same application, the AMS can send appropriate instructions to network load balancers/switches to stop sending load to some of the servers. Once load ceases to arrive at a server, the server can also be sent instruction to go to a low power state. The AMS continues to monitor incoming load and based on the request rate and response time, can make decisions to further minimise active servers or “wake-up” the servers to serve additional load.

(viii) Proactive Management: The discovery capabilities of the AMS can allow Transmission Control Protocol/Internet Protocol (TCP/IP) traffic to be diverted to a specially configured AMS. This AMS understands the application, service or component from prior exposure. With load being directed to it, the AMS is in a position to offer greater reliability and management of the application, service or component. This capability converts the passive management capabilities of the AMS into active management capabilities.

(ix) The AMS is the basis of a management platform and provides application management services such as service level monitoring and failure management for applications, services, components and/or the like.

### BRIEF DESCRIPTION OF FIGURES

An example embodiment of the present invention should become apparent from the following description, which is given by way of example only, of a preferred but non-limiting embodiment, described in connection with the accompanying figures.

FIG. 1 illustrates a functional block diagram of an example processing system that can be utilised to embody or give effect to a particular embodiment;

FIG. 2A illustrates an Application Management System (AMS);

FIG. 2B illustrates a method for managing one or more applications;

FIG. 3 illustrates a more detailed architecture of the application management system;

FIG. 4 illustrates an inline implementation of the AMS;

FIG. 5 illustrates a bus implementation of the AMS;

FIG. 6 illustrates a possible separation of AMS components;

FIG. 7 illustrates multiple tracking units per Data Store;

FIG. 8 illustrates a connection instance in the AMS;

FIG. 9 illustrates an example screen shot of a Reporting Engine; and,

FIG. 10 illustrates an example traffic distribution of a Web server cluster.

### MODES FOR CARRYING OUT THE INVENTION

The following modes, given by way of example only, are described in order to provide a more precise understanding of the subject matter of a preferred embodiment or embodiments.

In the figures, incorporated to illustrate features of an example embodiment, like reference numerals are used to identify like parts throughout the figures.

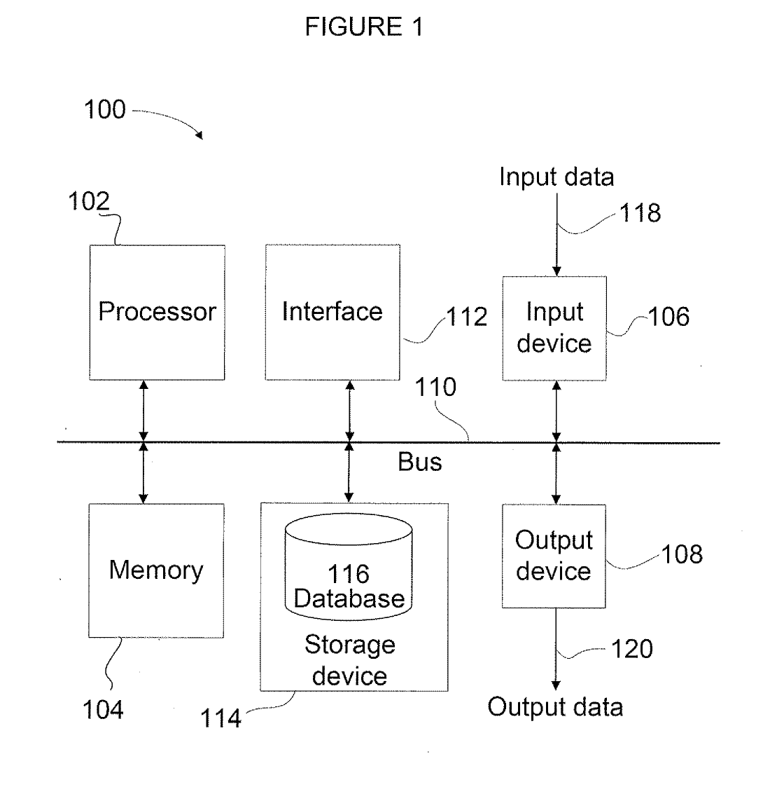

A particular embodiment of the present invention can be realised using a processing system, an example of which is shown in FIG. 1. In particular, the processing system 100 generally includes at least one processor 102, or processing unit or plurality of processors, memory 104, at least one input device 106 and at least one output device 108, coupled together via a bus or group of buses 110. In certain embodiments, input device 106 and output device 108 could be the same device. An interface 112 can also be provided for coupling the processing system 100 to one or more peripheral devices. At least one storage device 114 which houses at least one data store 116 can also be provided. The memory 104 can be any form of memory device, for example, volatile or non-volatile memory, solid state storage devices, magnetic devices, etc. The processor 102 could include more than one distinct processing device, for example to handle different functions within the processing system 100.

Input device 106 receives input data 118 and can include, for example, a network interface or adapter. Output device 108 produces or generates output data 120 and can include, for example, a network interface or adapter. The storage device 114 can be any form of data or information storage means, for example, volatile or non-volatile memory, solid state storage devices, magnetic devices, etc.

In use, the processing system 100 is adapted to allow data or information to be stored in and/or retrieved from, via wired or wireless communication means, the at least one database 116 (i.e. one or more data store). The interface 112 may allow wired and/or wireless communication between the processing unit 102 and peripheral components that may serve a specialised purpose. More than one input device 106 and/or output device 108 can be provided. It should be appreciated that the processing system 100 may be any form of terminal, server, specialised hardware, or the like. The processing system 100 may be a part of a network, for example the Internet, a LAN, a WAN, etc. Input data 118 and output data 120 can be communicated to other devices via the network.

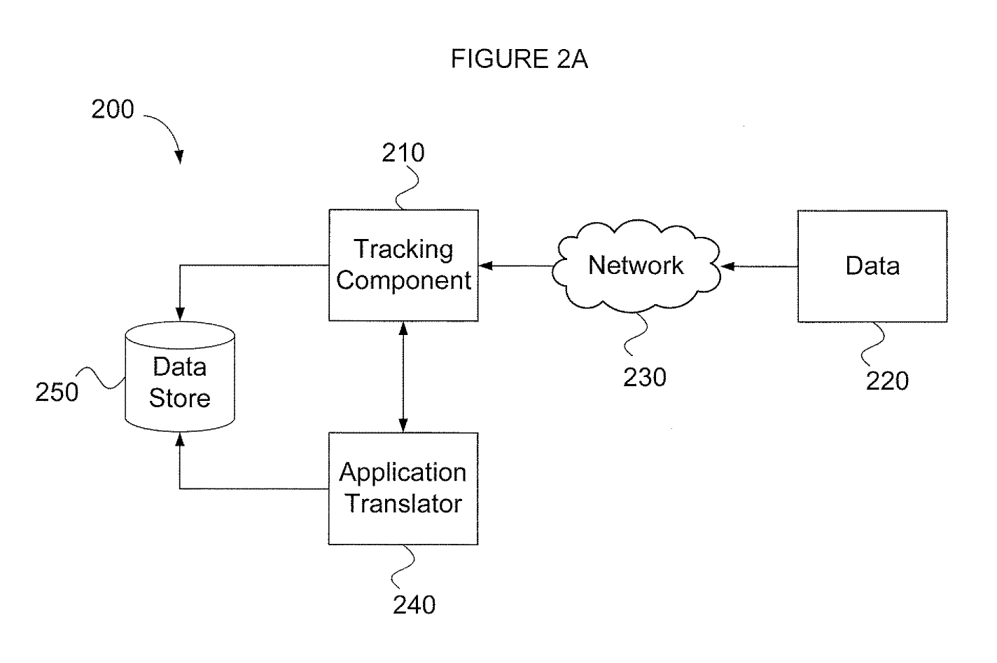

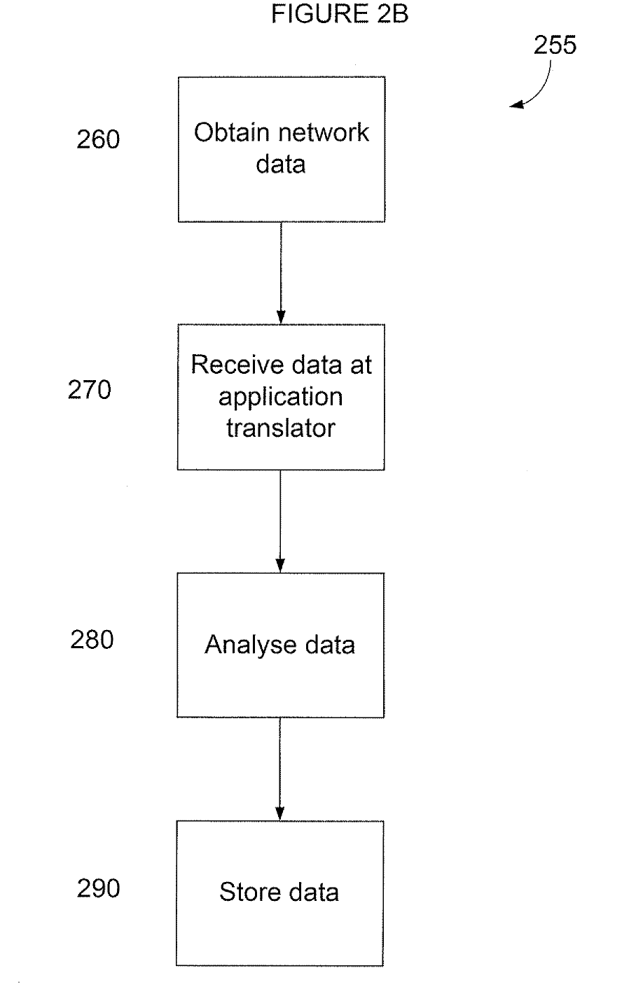

Referring to FIG. 2A, there is illustrated an Application Management System (AMS) 200. The AMS 200 includes a network tracking component 210 for obtaining network data 220 via a connection to at least one network 330. Tracking component 210 transmits at least part of the data 220 to an application translator 240. The application translator 240 is adapted to analyze the received data and provide or return analyzed data. The analyzed data can be returned to tracking component 210 and/or sent to data store 250 to be stored. Tracking component 210 can also communicate with data store 250.

In a particular example, the tracking component 210 can be a network tracking engine and the application translator 240 can be an application technology translator as hereinafter described.

Referring to FIG. 213, there is illustrated a method 255 of managing one or more applications. The method includes, at step 260, obtaining network data 220 using a network tracking component 210. At step 270, an application translator 240 receives at least part of the network data 220. At step 280, the application translator 240 analyzes the received network data and provides or returns analyzed data which can be stored in a data store 250 at step 290.

The application management system 200 and/or method 255 can be embodied as a computer program product for managing one or more applications. The computer program product can be wholly installed on a processing system or components of the computer program product can be distributed across more than one processing system.

It should be noted that more than one application translator 240 can be provided and the application translator 240 can be selected from a plurality of application translators by network tracking component 210 or some other component provided for such a purpose. A specific application translator 240 can be selected based on a network connection instance as hereinafter described. A selected application translator can be retained or not based on a type of further obtained or received network data. Thus, a selected application translator may be initially selected but removed or otherwise unselected as further data is received if the further data is not suitable or otherwise compatible with the initially selected application translator.

The application translator 240 can receive at least part of the network data 220 in a different format to the network data 220 as obtained by network tracking component 210. A different data format can be generated or produced by a filter component of the application management system 200. Network data 210 can be data that is transmitted between components of at least one distributed application. Alternatively, network data 210 can be data that is transmitted between two or more distributed applications.

It should be noted that reference to an application should be generally read as a reference to a Web service, program, database, component, tool, system or the like. Thus, an application can be a piece or component of software and/or hardware adapted to transmit data over a network with another application or component thereof.

Preferably, the application management system 200 is not installed on the same processing system as an application that is generating or communicating data 220. The application management system 200 can be used to detect network-based applications by monitoring and analyzing received or intercepted network data 220. Also, it should be noted that network data 220 can be received as a file of data, for example as a preformatted file. Preferably, there is one instance of network tracking component 210 for each network interface.

### FURTHER EXAMPLES

The following examples provide a more detailed discussion of particular embodiments. The examples are intended to be merely illustrative and not limiting to the scope of the present invention.

### 1. Architecture

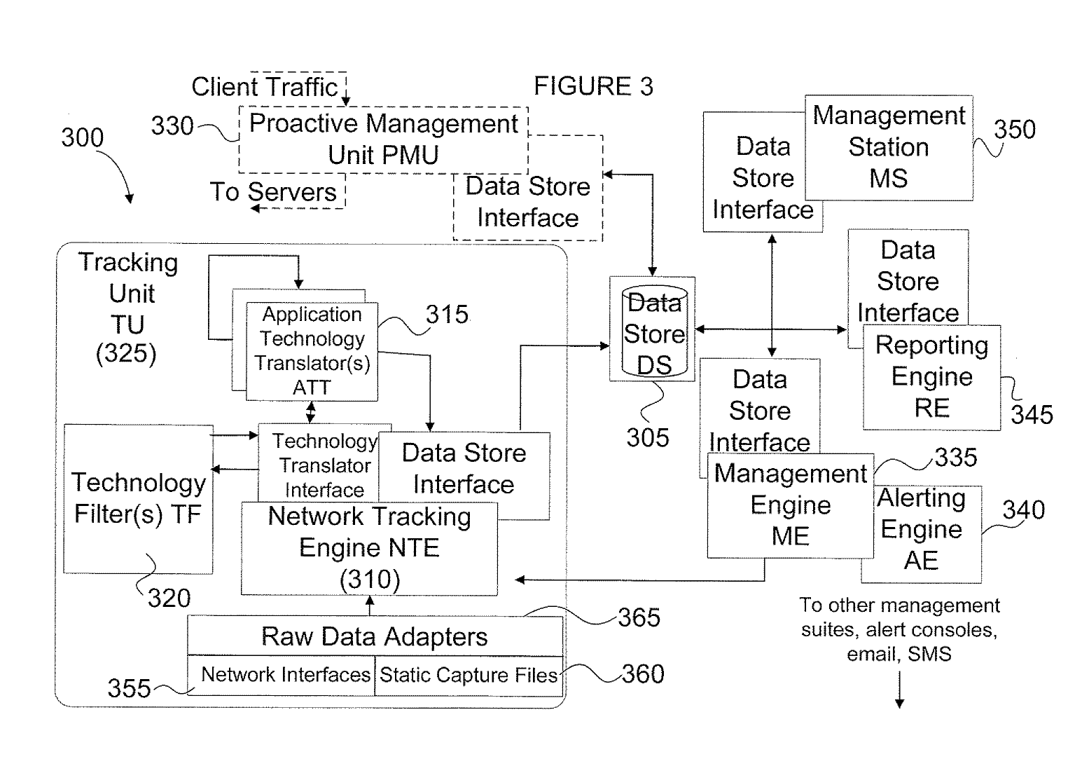

Referring to FIG. 3, this section describes the key subsystems of the Application Management System (AMS) 300 and how the components interact to deliver the AMS services.

### 1.1 Data Store (DS) 305

Data Store (DS) 305 is the store for persistent runtime information about applications, web requests, database queries, VoIP calls, mainframe transaction interactions and other application technology interactions of interest. DS 305 is designed to be extensible with new types of objects over time, DS 305 also contains the runtime configuration information for AMS 300. DS 305 is fed live information from a network tracking engine, used as the data source for standard reports, fed configuration information and provides runtime alerts for AMS 300.

### 1.2 Network Tracking Engine (NTE) 310

Network Tracking Engine (NTE) 310 is the component of AMS 300 that monitors networks connected to the physical computer system on which NTE 310 is running. NTE 310 can also be instructed to process data in a pre-formatted file as if it were information coming off a live network connection. NTE 310 traces all TCP/IP connections and attempts to determine what sort of traffic and application is running over those connections. NTE 310 also deals with the more difficult aspects of networking, i.e. NTE 310 reassembles out of order network messages into the correct order and removes duplicate network frames before passing the network information on to an Application Technology Translator (ATT) for further processing. There is one instance of an NTE 310 per network interface (or file). It is quite possible that multiple NTEs 310 can be running at the same time on the same physical computer processing network traffic from different physical networks.

### 1.3 Application Technology Translators (ATT) 315

The Application Technology Translators (ATT) 315 are loaded by NTE 310 to do specific analysis for an application technology which they understand. Whenever NTE 310 detects a new TCP/IP connection instance NTE 310 looks at the meta-data of all the ATTs 315 configured in DS 305. If the meta-data of the ATTs 315 indicates a potential match, NTE 310 passes the network data to the ATTs 315 for further analysis. There is no limit on the number or type of ATTs 315 in AMS 300 and it is expected that as new services and data formats become established over time, AMS 300 will have new ATTs 315 added dynamically. Preferably, although not necessarily, ATTs 315 are packaged as dynamically loaded modules. In a particular example implementation on Windows, the ATTs 315 are packaged as Dynamic Linked Libraries (DLLs) with a specific set of interfaces, NTE 310 dynamically loads ATTs 315 and executes their initialization routines before sending any traffic to them.

### 1.4 Technology Filters (TF) 320

Technology Filters (TF) 320 are specific components that are able to take the outputs of NTE 310 and modify the output into a different format so that the content is presented to ATTs 315 in a format they understand. A typical example of this is when the interface of an application uses Secure Sockets Layer (SSL). With SSL, all of the data is encrypted and cannot be processed in a standard way ATTs 315 process information. An SSL Technology Filter can use the private key from a target server (installed into AMS 300) to decrypt the data coming into AMS 300 and can then present the data to a specific ATT for further processing. A similar case exists for compressed information.

### 1.5 Tracking Unit (TU) 325

Tracking Unit (TU) 325 is the combination of at least NTE 310, one or more ATTs 315 and one or more TFs 320. These components can typically be deployed as a unit.

### 1.6 Proactive Management Unit (PMU) 330

PMU 330 performs proactive management functions for applications and services. For example, system administrators can change the address of where client programs find a service in their Domain Name System (DNS) system to the address of PMU 330. The DNS is the address book relating human readable names to computer addresses. When a client's computer connects to PMU 330, then PMU 330 is able to look up the application that is being requested, the physical computers running that application and is then able to forward on the request to one of the servicing computers. PMU 330 can then enhance the applications from a scalability, reliability and performance perspective.

Another example of where PMU 330 provides proactive management ability is in assisting computer installations minimise/reduce power usage. The PMU has the ability to detect when a group of servers are hosting the same content/transactions (detected automatically through AMS functionality or through specific administrative configuration). Once a set of servers are determined to be running the same content, the PMU will send messages to the load balancers/switches in the environment to stop sending load to one of the servers and optionally a message to the server when all outstanding work is complete to go to a low power state. The AMS will monitor the incoming request rate and response time of the other servers also running the application/service to ensure that service levels are not adversely affected by the removal of one physical server. After a time period, the PMU will send messages to the load balancer/switches to stop sending load to another server and so on. Eventually, the smallest set of servers required to serve the application will remain. If the incoming load increases, the PMU will send messages to bring servers back from their low power states and will send messages to load balancers/switches to send load to the servers.

### 1.7 Management Engine (ME) 335

Management Engine (ME) 335 is the part of AMS 300 that looks at the configuration in DS 305 and takes management actions should failures occur or if application performance thresholds are exceeded (or otherwise not met). ME 335 also looks at historical performance trending (available in DS 305) and can issue a warning or alert in the case of a situation where an application performance trend is changing considerably from usual or expected behaviour.

### 1.8 Alerting Engine (AE) 340

Alerting Engine (AE) 340 generates and delivers required alerts according to a policy and the configuration in the DS 305. AE 340 can also take action to correct a specific issue by communicating with PMU 330 if PMU 330 is in use. AE 340 also integrates with other commercially available management systems through Simple Network Management Protocol (SNMP), its own Simple Object Access Protocol (SOAP) interface, WS-management and other commercially available management information transport systems.

### 1.9 Reporting Engine (RE) 345

Reporting Engine (RE) 345 is the part of AMS 300 that generates customized and standard reports based on the configuration and need of a particular implementation. RE 345 derives its information from DS 305.

### 1.10 Management Station (MS) 350

Management Station (MS) 350 refers to the user interface console and the set of interfaces on DS 305, NTE 310, PMU 330, ME 335 and AE 340 that offers a mechanism for user interface consoles to obtain access to information and allow the update of AMS 300 configuration. MS 350 can provide information in the following views: physical server view; services view; client (workstation) view and other views such as “application” or user-defined “group” views. Each view has a default object type which can have context-specific management and historical functionality presented for the object. As an example, in the service view, an example object could be the organisations' employee self service web portal. MS 350 also has a “back-channel” interface to the DS 305/ME 335 so that if a configuration change, other data store or management alert occurs while the management station is running, MS 350 is notified. MS 350 can also contain access to RE 345 functionality.

### 1.11 Update Engine (UE)

The Update Engine (UE) (not illustrated) is embedded in all of the components of AMS 300. The UE's function is to test for a connection to the Internet to download software updates for the specific component the UE is being hosted in. The UE also works in concert with RE 345 to interrogate DS 305 to track the services that are being managed through AMS 300. Overall AMS 300 can be charged to a customer on the basis of the number of services being managed for the period of time they are managed. If the UE is able to see the Internet, the UE can establish a secure session with the software company that released AMS 300 and send in the details of usage on a frequent or periodic basis.

Another function that the UE can perform is to download limited function ATTs 315 for functionality that is not yet included in AMS 300. The limited function ATTs 315 perform a very efficient limited test for the presence of the application technology they are designed to manage. If the technology type in question is found in the network, the system administrators are informed that AMS 300 can also provide that service the next time a system administrator starts MS 350.

### 1.12 Physical Implementation

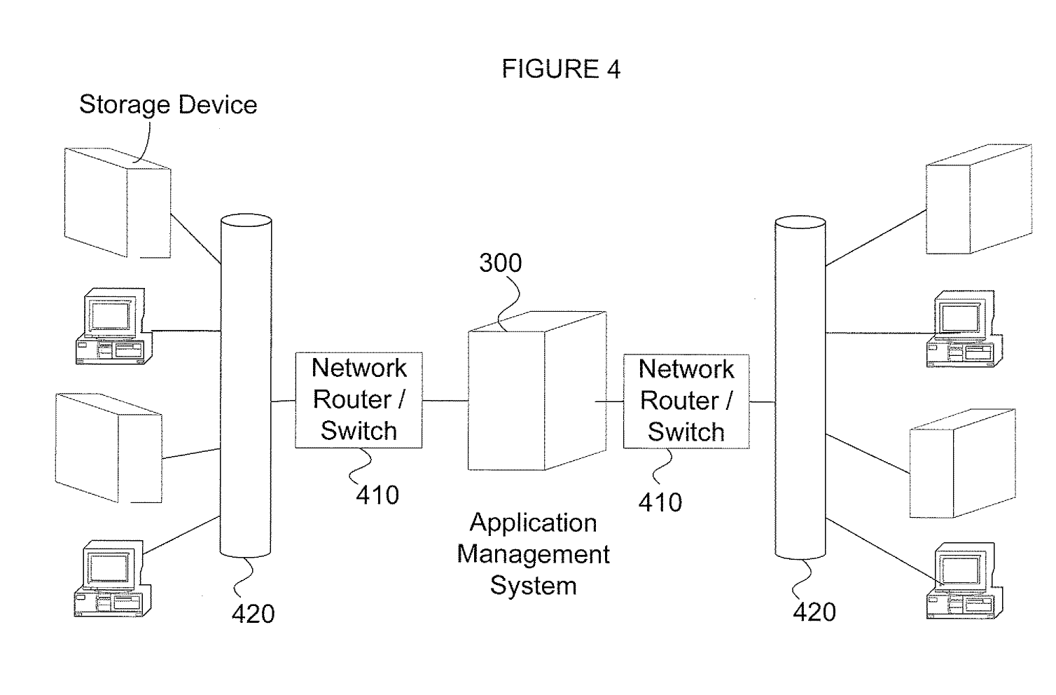

(i) Inline Implementation: Referring to FIG. 4, AMS 300 can be placed inline in a network connection between two nodes 410 or networks 420 to intercept all of the network traffic going across the link without changing the traffic. As the traffic propagates across the link the traffic is processed by NTE 310.

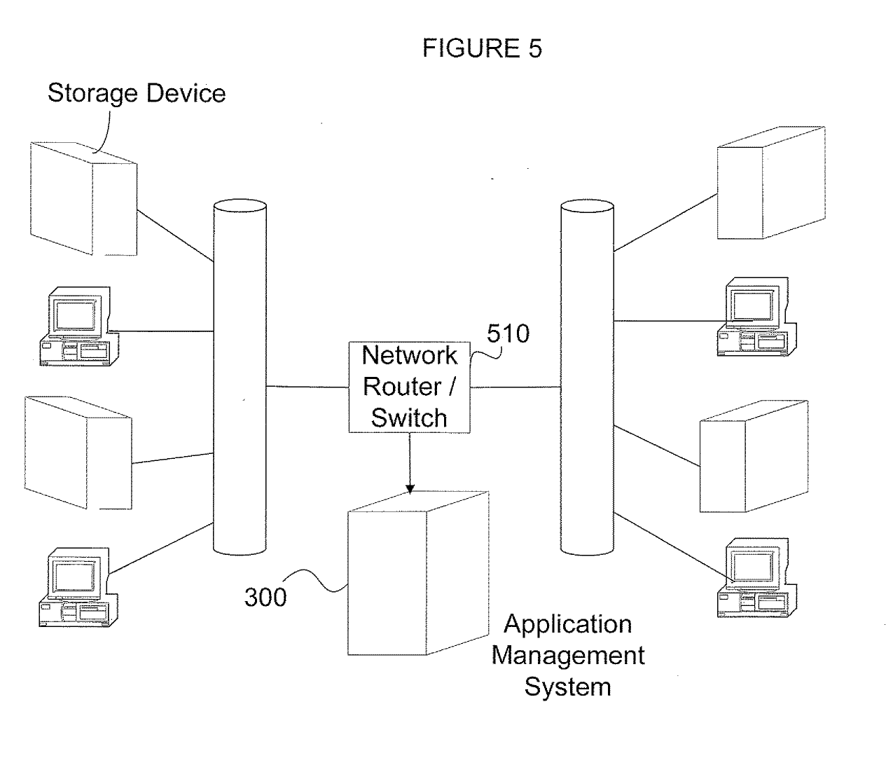

(ii) Bus implementation: Referring to FIG. 5, AMS 300 can be plugged into a switch/load balancer 510 or other similar network device which sends the networks' entire load to NTE 310. This allows the specific instance of NTE 310 to interrogate all of the traffic on that network. Alternatively, AMS 300 can be embedded into a network management device as an additional capability of the device. The bus implementation is the preferred implementation style as the reliability of AMS 300 is not a factor in the overall implementations' reliability. When AMS 300 is configured in the inline configuration, a failure or slowdown in AMS 300 could affect all of the systems on the network.

### 1.13 Separation of Components

The various components of AMS 300 can be designed with a built-in assumption that some of the components can be separated at runtime to: increase the number of applications AMS 300 can manage; scale AMS 300; and/or support lighter weight implementation models for organisations with applications that are not very busy.

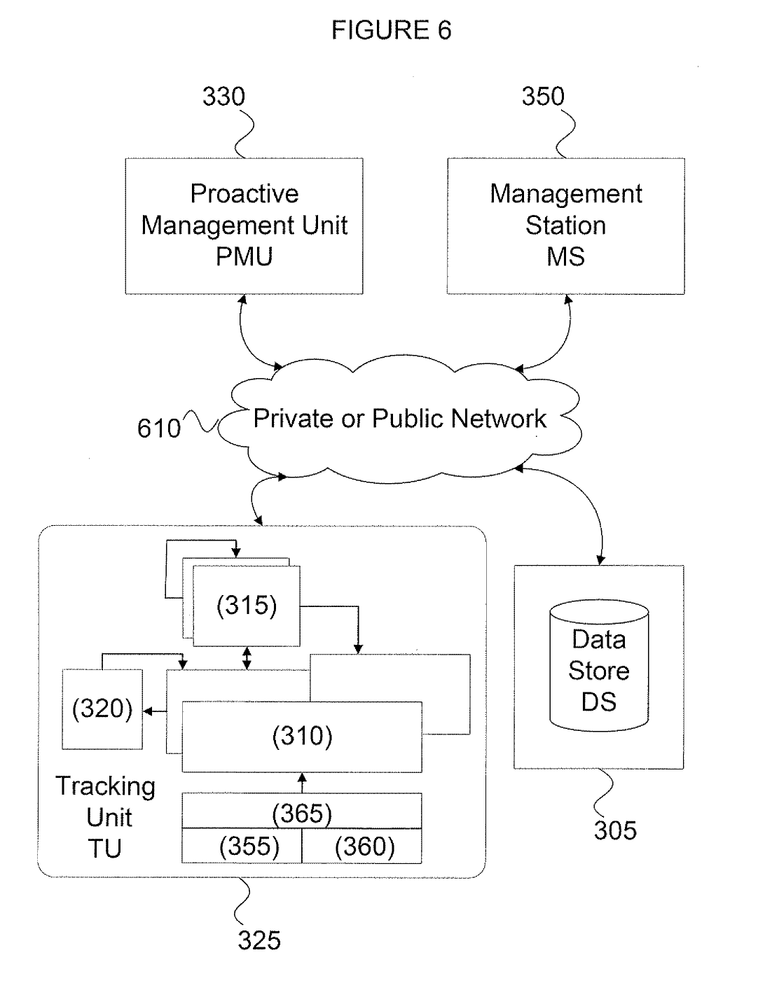

FIG. 6 illustrates various components of AMS 300 that can be separated. Each one of the TU 325, DS 305, MS 350 and PMU 330 can be on separate physical hardware and be separated by private or public networks 610. For example, it is possible for an organisation to only deploy a TU 325 and a few MS 350 with the DS 305 being hosted by another company connected via the Internet, In this case, TU 325 and MSs 350 connect to DS 305 over the Internet.

### 1.14 Aggregation

The scope of a specific AMS 300 is purely related to the network traffic that is propagated across a link being monitored. This essentially means that the traffic seen is traffic destined for the servers connected to the switch/load balancer, the clients connected to the switch/load balancer and the traffic being routed through the device on its way to other parts of the network.

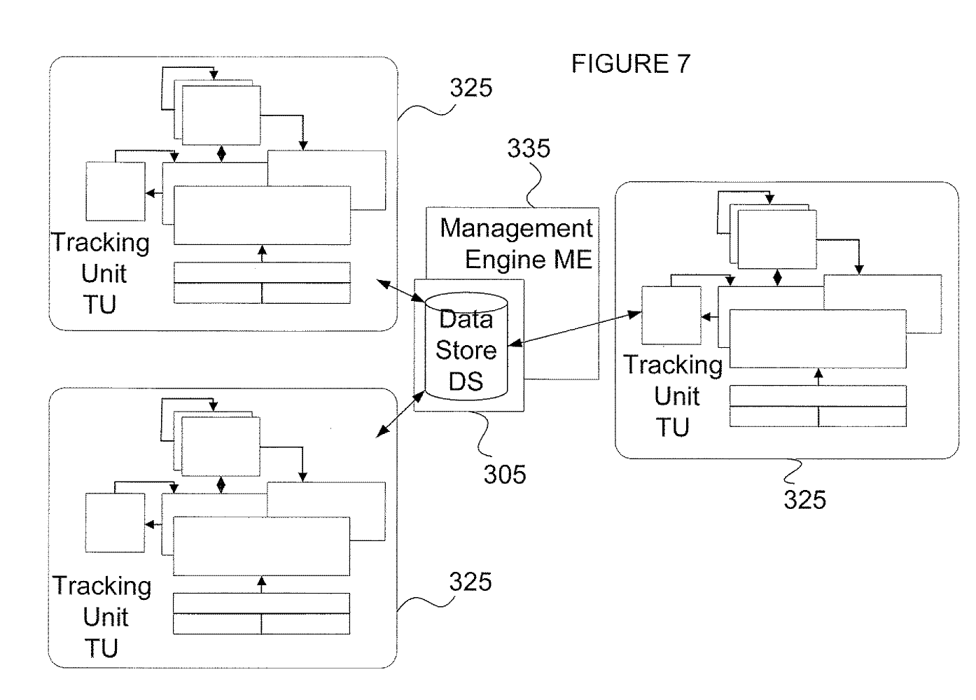

Referring to FIG. 7, DS 305 in AMS 300 is preferably keyed and indexed in such a fashion that multiple TUs 325 can pass data to a single DS 305 which has the result of allowing the traffic from multiple networks to be processed in the one instance of an AMS 300.

(i) Resolution of duplicate management data: While the multiple TUs 325 are sending management data from different networks and workloads, it is possible that the multiple TUs 325 can send duplicate information to DS 305. DS 305 and ME 335 leverage the relational database functionality of DS 305 to avoid this situation, as the management information is being inserted into DS 305, the database keys being used on the tables can detect a duplicate record and not allow its insertion. A TU 325 is notified to this failure and may delete all of its internal state for the interaction that is being managed by another TU 325.

(ii) Aggregating multiple AMSs: It is also possible to couple several complete AMSs 300 through the use of the datastore queries aggregating information across multiple datastores. These multi-datastore queries would be developed to only show unique data and would further aggregate the information (if necessary).

### 2. User Perspective

An initial user perspective of using AMS 300 is noted to aid in the understanding of the management system. From a users' perspective, getting started with AMS 300 is very straight forward. In a particular example the general process would be:

(i) Deploy the AMS device or software (could be packaged as either) into a network environment;

(ii) Select the network switches/routers that require management from the AMS and plug the AMS network interfaces into switch ports which have the entire load from these networks;

(iii) Install and start-up the MS component on a PC in the corporate network;

(iv) Start the MS. This should detect that this is the first time this software has been run and can direct the user to the AMS systems found in the network. One of the AMS systems is selected;

(v) This should advertise the servers/services and clients found by that AMS. The MS user selects the object they want to manage;

(vi) The MS user can also make decisions to aggregate various “found” servers or services into applications & groups. Applications & groups are an additional management/aggregation unit; and

(vii) The user selects the style of error/alert messages they want. SNMP, console messages, emails, SMS messages and (if necessary) the network location/address/email to which to send these messages.

### 3. Functionality Description

This section provides further details in describing the functionality of various components in a particular, but non-limiting, example of the Application Management System.

### 3.1 NTE Startup

The majority of the configuration information for the NTE is found in the DS, so the raw inputs to the initialisation process are to provide the NTE with a location where to find the DS and to provide the DS with the network interface name or the file name for the load that will be processed.

This information is passed to the NTE through a command line interface. If the input parameters instruct the NTE to read a network interface, the NTE uses the operating system primitives, i.e. Application Programming Interfaces (APIs), of the platform the NTE is running on to communicate with a network driver or other implementation to obtain access to the raw Ethernet frames coming off the network. If the input parameters dictate that the data to be processed is coming from a file, the NTE uses operating system primitives to open the file, and read and format the data so that the data can be processed by the NTE.

As illustrated in FIG. 3, regardless of whether the data is live from a network interface 355 or whether the data is coming through a file interface 360, the data is standardised through an adapter 365. It is possible for adapter 365 to have other types of input methods or receive other types or formats of data.

On connection to the DS, the NTE reads the entire set of configuration parameters related to the NTE and reads a table that contains a list of ATTs for the NTE to load. The configuration preferably includes the ATT name, a general name for the technology that the ATT understands, and information relevant to the ATT (i.e. a superset of the instances where the NTE should send traffic to the ATT, the ATT might still reject the traffic subject to further inspection).

The data coming from the DS, may also indicate which servers, services or client machines/terminals the NTE should manage (i.e. continually inspect, analyze and store information for). The configuration information might suggest a group of any of these object types which is an instruction to the NTE to perform the action for all the members of the group.

### 3.2 Setup of ATTs

Each ATT has a minimum set of interfaces that the ATT publishes to an NTE in order for the ATT to be successfully loaded and sent network information for analysis. Part of the interface for the ATT is an interface where the NTE asks the ATT whether the connection instance is recognised by the ATT or not. The ATT uses this opportunity to sample the traffic and inform the NTE for the connection instance whether the traffic is for the NTE, or not, or whether the ATT is not sure (in which case the NTE keeps sending information until the ATT returns a ‘Yes’ or ‘No’ type response).

On ATT initialisation, the ATT also negotiates access to a set of services the NTE provides. These can include:
(i) Access to the DS;
(ii) An in memory copy of the configuration information for the DTE;
(iii) A list of all the current connection instances being tracked by the particular NTE; and/or
(iv) A list of all of the other ATTs loaded for a particular NTE. (It is possible for one ATT to daisy chain with another related ATT if a situation calls for such an arrangement).

### 3.3 NTE Standard Processing

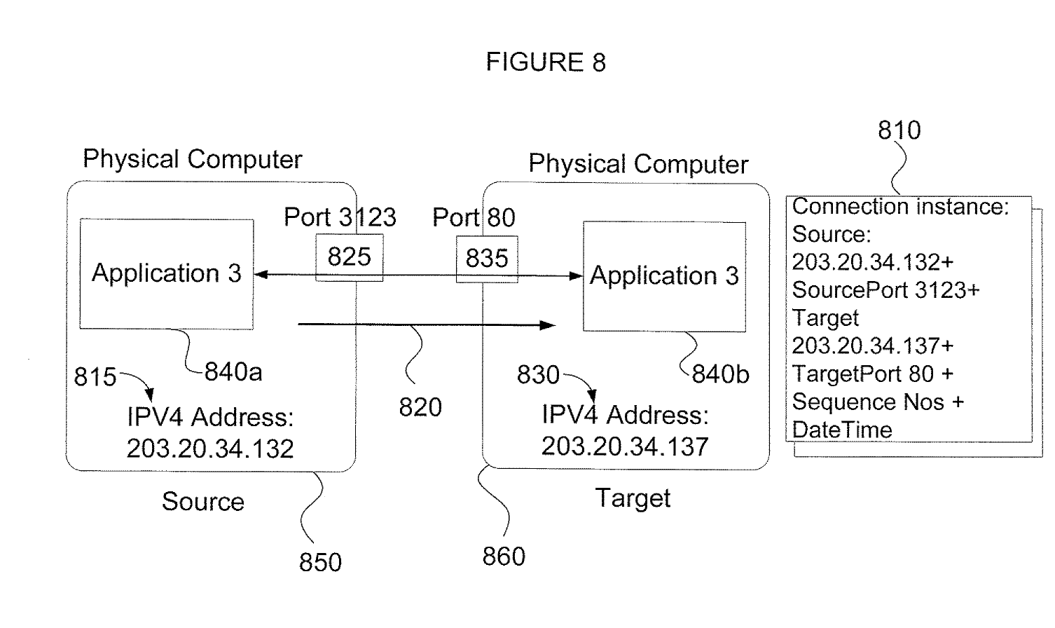

Referring to FIG. 8, standard processing of the NTE centres on the concept of a connection instance. A connection instance 810 is the combination of an address 815 (for example IP version 4 or IP version 6 addresses) of a computing node initiating a communication 820, a source port 825 (a port in the TCP/IP sense of the word) of a sending node, a network address 830 of a target node, a target port 835, sequence numbers established with the connection and the use of a DateTime stamp to provide additional uniqueness for the connection instance.

This combination of data represents a unique “conversation” between two distributed parts of an application or two distributed applications 840a, 840b. A connection instance in the AMS is identified by the addition of the SourceAddress, SourcePort, TargetAddress, TargetPort and session SequenceNumbers. DateTime is an additional field that is captured that can be used in the remote change of a collision in a large volume of data.

### 3.3.1 Discovery of a Connection Instance

A connection instance 810 can be discovered by the NTE by simply looking for the combination of a TCP/IP SYN-SYNACK, ACK pattern (e.g. using TCP/IP RFC793) between two distributed computers 850, 860. Once this pattern is found, the NTE allocates an object in memory to represent the connection instance and alerts the DS that this connection instance is “in flight”. The DS inserts a record into a table to mark this beginning of a connection instance.

The NTE then checks configurations for a set of ATTs that might be interested in this connection instance based on the attributes of SourceAddress, SourcePort, TargetAddress or TargetPort (or combinations thereof). The NTE can send all of the subsequent flow of frames to all of the ATTs in the set until each individual ATT responds with an indication that the ATT is interested in the connection instance, that the ATT is not interested in the connection instance, or that the ATT is not sure (so keep sending the frames).

### 3.3.2 Shutdown of a Connection Instance

Conversely, a Connection Instance is shutdown when the TCP/IP, FIN flag is sent by both the source and target side of the conversation and when either side of the conversation sends a RST flag. In these instances, the NTE alerts all of the ATTs receiving the frame flow for the connection instance that the connection instance is going down, The NTE also sends a message to the DS to update the connection instance record with the connection close data. Once the connection instance has been persisted, the in-memory representation is deallocated.

### 3.3.3 Connection Instance Management

The NTE maintains a collection (for example by using a hash table of objects in memory) of all of the currently active connection instances and calculates a unique identifier of the connection instance and can then send the frame to the connection instance.

### 3.3.4 Connection Instance Data

The information held about connection instances can include the source/target addresses and ports, sequence numbers, start time of the connection instance, end time of the connection instance, the number of frames sent on the connection instance, the total number of bytes sent over those frames, the total number of data (payload) bytes, the source and target Media Access Code (MAC) addresses (a unique identifier for the network card that was either the source or target in a connection instance), and an identifier denoting the technology types (ATT types) that further processed the flow of traffic on the connection instance, From this data, the overall connection time of the connection instance can be determined and the efficiency of the usage of the connection instance (ratio of total bytes sent to data bytes sent).

### 3.3.5 Technology Filter Interaction

TFs also have their configuration in the DS. The NTE can look at the TF configuration first before sending connection instance flows to ATTs. If there is match for a TF, the TF is called to convert the information into a readable format for the ATTs. An example of this would be SSL connections. If a connection instance is made where the target port is port 4433 the NTE can pass the data from the network frames to the SSL technology filter, the SSL technology filter can decrypt the data and then pass back the data. Subsequently, other ATTs would be sent the data and processing would continue as normal. The TF also sends a message to the DS that the TF was functioning on a connection instance,

### 3.3.6 Already In-Flight Connection Instances

There are instances where applications make TCP/IP connections and re-use these connections for thousands of interactions. In these instances, the AMS has the facility to process the in-flight connection instance. The process for doing this is similar to the normal process for complete connection instances in that the ATTs are selected that are candidates for processing the information, The ATTs receive the information for in-flight connection instances through a different interface specifically for the in-flight inspection of data. In these situations, the connection instance in the DS is marked as being in-flight and the start time represents the time that the connection instance was first being monitored.

### 3.3.7 Timing Out Connection Instances

There are some instances where frames are lost or connection instances are abandoned. In order to cater for this situation, each connection instance in-memory object has a timestamp field which contains a timestamp for which the last network activity for the connection occurred. The AMS looks through all running connection instance in-memory objects that have not had activity for a certain time period. If the time period exceeds the AMS timeout, the connection instances are persisted to the DS and are freed from memory.

### 3.3.8 Other Services Provided by the NTE

Production networks often have network frames arrive out of order and have frames re-transmitted resulting in duplicates. The NTE deals with these conditions and may only pass in single copies of frames in order to the TF and ATT components. The NTE also provides a location on its in-memory objects for ATTs to additionally store data. The expectation is that if there is no ATT interested in processing the connection instance these extra locations are empty, but if there are one or more ATTs processing the information coming through the connection instance these locations are not empty.

### 3.4 Common TF Processing Cases

Some of the most common uses for TFs are the decryption of SSL streams and the decompression of streams that have had GZIP compression applied. The configuration data to determine which filter to use can be as follows:

(i) SSL—Connection instances with TargetPort of 443 and other (user configured ports);

(ii) GZIP Compression—Connection instances where the first two bytes of the data stream or payload are 0x1F 0x8b indicate a data stream that is compressed.

### 3.5 ATT Processing

The ATTs process relatively independently of the NTE. The ATTs have a standard set of interfaces that the ATTs support, but after this standard set of interfaces the ATTs are free to process data as necessary, buffer, store, etc. Multiple ATTs can be interested in the flow of network frames coming through a connection instance. As an example of this, in practice, most SOAP web service calls are propagated on top of the HTTP protocol. In the AMS, this would result in the “Web” ATT and the “SOAP” ATT both being sent the flow of frames from a specific connection instance.

### 3.5.1 Nominating Interest in Data Flow Through a Connection Instance

In addition to a configuration providing hints as to the types of traffic to be sent to an ATT, there is also a protocol the ATTs have with the NTE to inform the NTE to keep sending traffic or to inform the NTE that the traffic is not of interest. Each ATT has an interface that the NTE calls with data and the ATT returns a response of “Yes”, “No” or “Maybe”. The “Maybe” response informs the NTE to keep sending data from that connection instance to the ATT as the ATT needs a greater amount of data to determine whether the data flow is relevant to that specific ATT, It is also possible for an ATT to have configuration data for the ATT set at “i”. This informs the NTE that flows of data from all connections instances should be sent to that ATT.

### 3.5.2 Persistence to DS

One of the other standard interfaces the ATTs preferably require is an interface to persist the additional ATT state of a connection instance when the connection instance is closing and the in-memory object is being shutdown. For example, all the AMS ATTs may use a common set of utility functionality (supplied by the NTE) to persist their information to the DS. The persistence to the DS is all asynchronous. This may be necessary to allow the NTE and the ATTs to avoid high latency processing. It is imperative that the AMS sustains the performance of the NTE and the ATT components.

### 3.5.3 Primary Interaction Type

Most ATTs have a higher order unit of work or abstraction above the connection instance that is meaningful from an application standpoint. This is typical due to the fact that the ATTs are designed to function above the network protocols deriving application-centric meaning from the interactions between different pieces of software over a network. As an example, a web browser typically establishes a TCP/IP connection (connection instance) to a web server and serially sends numerous web requests over that connection. In the case of the Web ATT, each web request is a meaningful application level interaction type. For the Web ATT this interaction type can be referred to as a URI instance. For example, these URI instances might be requests for specific pieces of information or commands to “buy” the contents of a shopping cart, This primary interaction type is the most relevant object to be managed and monitored for the Web ATT.

### 3.5.4 Web ATT

The Web ATT has specific knowledge of the HTTP protocol (refer to RFC2616 for details on the HTTP protocol). The Web ATT checks that the first part of the TCP/IP body frame being sent from a client to a server is a HTTP verb and that before a carriage return-linefeed combination of characters is found in the frame, the HTTP version characters are found, i.e. “HTTP/1.1 or HTTP/1.0”. These pieces of information allow for the identification of a connection instance that is carrying Web (HTTP) traffic. The ATT can allocate a specific in-memory object to track the specific Web attributes of this connection instance which include the DNS hostname of the server and the type (manufacturer) of the web server.

Subsequently, the ATT sets up to buffer the HTTP request header (as the request header should be processed when the request header is complete). The ATT captures all of the data frames coming from the client and assembles them while looking for the end marker of the request header (character sequence of carriage return/linefeed/carriage return/line feed). Once the complete request header has arrived and is assembled, the ATT looks through to extract details about the interaction, such as content type, content encoding, URI, Query string, HTTP verb, service name, request cookies and/or other data. The ATT can then switch into response processing mode, buffering all of the server response headers and extracting relevant details from the response headers.

In addition to capturing the granular information about the request and response, the ATT can be structured to be very particular regarding the timing of the request. The in-memory objects note the timestamps of the time the first request was seen, the time the server first responded and the time that the final part of the data response was acknowledged by the client (this is the final TCP/IP ACK coming from the client to acknowledge the last portion of data has been received).

The deltas between these timings provide detailed real timing information regarding the processing time and responsiveness of an application(s). It is also possible to factor in the data transfers and apply an averaging to cover the propagation delay of the networks involved in the system and provide true end to end performance characteristics.

The data from the URI instance can be persisted at any time after the request/response has been completed. The DS has a relational database relationship between the table that contains the connection instances, the table that contains the HTTP specifics of the connection instance and the set of URI instances that occur over this connection instance. As long as the records for the connection instance and the HTTP connection instance are in place, the URI instance can be placed into the DS. It is also possible to buffer the URI instance in memory and persist all of the URI instance details when the connection instance finally is closed. This is an implementation detail based on the traffic to the DS and the overall performance of the AMS.

The Web ATT can also encounter the condition where the current URI instance is incomplete when a new URI instance is found on a connection. The Web ATT has built in rules that mark a URI instance as incomplete and persist the URI instance in the DS as such. The Web ATT also has rules about what to do with the timing information based on when the last piece of information related to a URI instance came in. The Web ATT maintains the last seen frame timestamp and can revert to the timestamp as the end of an interaction when a URI instance is incomplete.

### 3.5.5 Microsoft® SQL Database ATT

The Microsoft Database ATT has knowledge of the interactions between applications and Microsoft SQL Server Databases. This ATT is able to diagnose database errors, deadlocks, timing on database queries including overall end to end timing of queries and provide an end listing of the database queries that occurred.

The wire protocol used by Microsoft SQL database is referred to as the Tabular Stream Protocol (TDS). TDS functions by having a standard record header in the first part of the data payload. This record header contains a record type, a last packet indicator, a size field which describes the size of the data and a random field. Following this header is the actual data relating to the packet type. The primary interaction type for the Microsoft SQL Database ATT is referred to as the Microsoft SQL Command. Many MSSQL Commands are typically sent over the connection instance.

On a database connection start-up, the pattern of frames coming from a SQL server is such that a packet with record type of 0x4 comes from the server part of the connection. This frame contains the database name and the database version. This is a key indicator that the connection instance is a SQL server connection instance.

The ATT then goes into a mode of searching for the client request header from the stream of data. Once the client header is found all of the frames associated with the client header are collected and assembled. Once the client query is assembled, the TDS data structure is navigated and the SQL Query or SQL Command being issue to the database is extracted from the data stream. At this stage, the SQL Server database processes the query and sends back the response. The response is formatted into a data structure which has metadata describing the response rows. This might be a simple integer or thousands of rows to be displayed and further processed.

The Microsoft SQL Database ATT takes timings at all of the relevant points of the MSSQL Command (beginning, first response from the server and end of response) providing significant timing information regarding the database query. Other information that is captured and persisted as part of the MSSQL command instance include the SQL Command executed, flags specifying whether the command is a SELECT or EXEC, the number of client frames and the number of server frames, the actual bytes that make up the data carried in the frames (a measure of database efficiency), database name and database server name.

In a similar mechanism to the Web ATT there is an option to persist the MSSQL Command instance as soon as completed or to buffer and persist when the connection instance is shutting down, It should be noted that the Microsoft SQL data flows can also be SSL encrypted; in which case the SSL TF would be used in much the same way the SSL TF is used in the Web ATT case.

### 3.5.6 Oracle® Database ATT

The Oracle Database ATT functions in a similar way to the Microsoft SQL ATT, and has a defined protocol which the Oracle Database ATT understands and a record format that identifies the various records as they are received. The primary interaction type can be referred to as OracleQry instance.

A notable difference in the way in which the session is established includes when a client is looking to establish a session with the Oracle database, the client connects on a well-known port (usually 1521) and then the Oracle server re-directs to connect to a different randomly allocated port which is in the response message. The AMS monitors and keeps track of these new ports and can also persist the initial port and the subsequent port to which the client is re-directed. Another difference in the Oracle Database ATT is that the Oracle Database ATT can read ASCII data where the Microsoft SQL ATT reads UNICODE data streams coming in from the network.

### 3.5.7 SOAP Web Service ATT (SOAP ATT)

This ATT leverages the highly structured XML SOAP messages for Web service interactions. The Primary interaction type for this ATT is the WS invocation instance. This is the SOAP request formatted request from one distributed application to another.

Given the design of SOAP web services being intended to be used on several different protocols, the ATT looks for XML encoded payloads which contain one of the following string sequences. These are indications that the request is a SOAP request and relevant to this ATT.

<env:Envelope xmlns:env=“http://schemas.xmlsoap.org/soap
<env:Envelope xmlns:env=“http://www.w3.org/2003/05/soap-envelope”>

The ATT can capture all of the request XML headers in the SOAP and split the headers out into the various headers and record metadata about each header. The request body is also optionally stored in the DS. In fact, an option in the AMS is to store all of the headers and the request body without modification subject to storage constraints.

The ATT can then transition into the server response expectation mode looking for the response. If a server responds with a SOAP error this can be reported. Optionally, other headers and response bodies can also have metadata recorded as an opportunity to actually store the complete response.

The SOAP ATT has some unique capabilities. It is possible for the data that the SOAP ATT places into the DS to be mined from a business standpoint as the request bodies and response bodies contain highly structure business transactions (so it is possible to use the SOAP ATTs data in the DS to answer business questions like: How many purchased orders were processed today?).

The PMU components also have the ability to have several Extensible Style Language Transformation (XSLT) transformations applied to the requests as they come into the PMU (refer to the discussion of the PMU), this effectively allows the PMU to act as a data transformation engine and to also propagate business transactions to other systems like data warehouses designed to capture business data.

Data the SOAP ATT persists includes meta-data about all of the headers contained in the request, timing information (similar to the Web ATT) and whether the SOAP request was a one way request or a request/response interaction.

### 3.5.8 Other ATTs

In addition to the ATTs described hereinbefore, there are numerous other types of possible ATTs. As non-limiting examples these include:

(i) VoIP ATT: This ATT extracts detailed information about the usage of the VoIP suite of protocols on a corporations' network, for example the number of phone calls made, the duration of the phone calls, the data consumed by the voice calls, the growth of voice calls over time and information regarding call degradation;

(ii) APPC ATT: APPC (Advanced Program to Program Communication) is a standard mechanism for non-mainframe platforms to communicate with IBM® mainframe applications. This ATT can also necessitate the development of a TF to convert Extended Binary-Coded Decimal-Interchange Code (EBCDIC) to American Standard Code for Information Interchange (ASCII) and vice versa, The APPC ATT can provide details on the number of mainframe requests being made, the timing of the mainframe requests, the errors and timeouts of mainframe requests and a history of mainframe requests response time; and,

(iii) IBM DB2 Database ATT: Is similar to the Microsoft SQL and Oracle ATTs, the IBM DB2 ATT can report the information regarding the queries, data and timing of requests to a DB2 database.

(iv) SMB ATT: The Server Message Block protocol is the Microsoft-designed remote file system protocol which is used in most common file server environments. This ATT extracts information about Microsoft-based remote file system requests in a network.

(v) NFS ATT: The Network File System protocol is the most common remote file sharing protocol found in UNIX environments. Like the SMB ATT, the NFS ATT detects and decomposes the remote file system requests for UNIX server environments.

### 3.6 Management Engine Processing (ME) Alert Engine (AE) Processing

The ME and AE are closely tied in terms of functionality. The ME is responsible when particular conditions need to be alerted and the AE takes charge of the alerting process. In addition to individual servers, services and clients, the AMS can be provided with the notion of a “group” or “applications”. A group/application is composed of a set of servers, services or clients. Whatever management actions can be taken on single instance of any of the above objects can also be accomplished on a “group” of these objects through the basic aggregation and averaging (dependent on the parameter being viewed/analyzed).

Preferably, by default, there are no servers/services/groups/applications or clients that are alerted on. It is only when an administrator of the system nominates a discovered service/server, group, application or client for alerting does the management engine start processing the messages coming into the DS for that object. In the simplest case, administrators can just nominate an object they want to be alerted about without specifying thresholds and the ME then assumes a default setting for the SLA (Service Level Agreement, or end to end response time) and can pass any important errors through. The default SLA could be 1500 milliseconds. The errors are defined by specific ATTs. If an administrator opts to take this route, the error alerts or SLA can be stored within the AMS and viewable through the Management Stations' alert log,

Administrators also have the ability to send alerts elsewhere to integrate with their other management systems. Administrators can choose to propagate alerts through SNMP (Simple Network Management Protocol), Email, SMS, etc. Depending on the type of alerting chosen, there may be a specific configuration required so that the AE can send the alert and notification successfully. The AE keeps track of the alerts in a circular log. After a certain number of entries, this log is recycled. The AE configuration is stored in the DS and different alerts can have different defined actions.

### 3.7 Reporting Engine (RE)

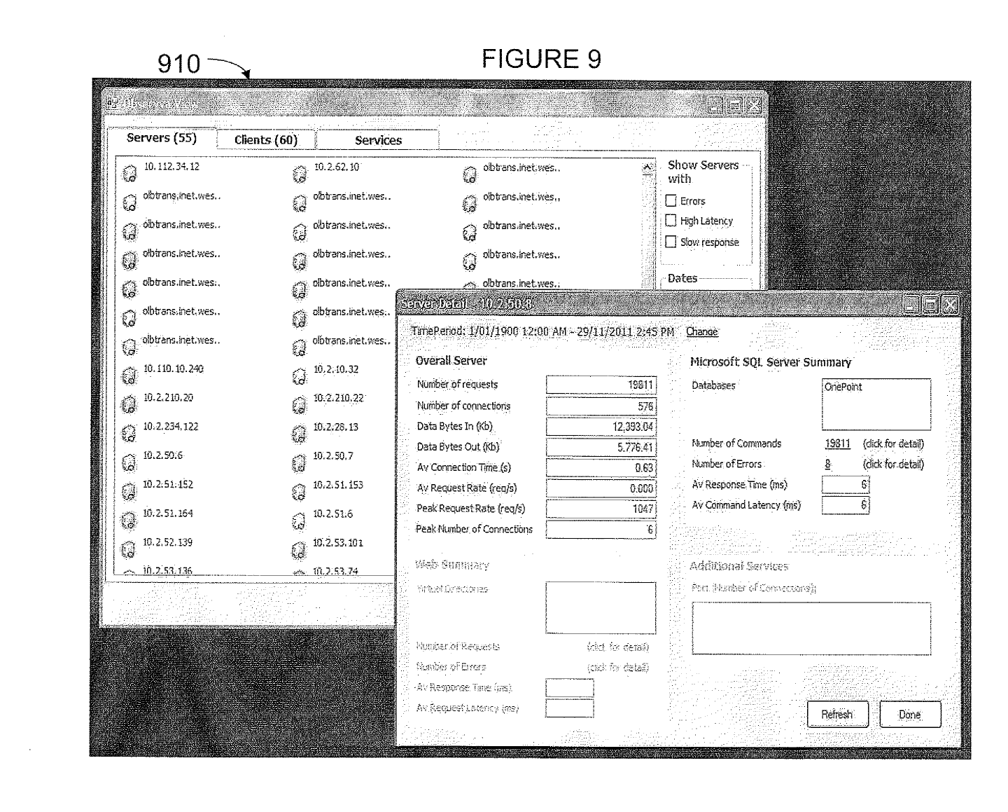

The RE provides up to date reports on the system being monitored. Referring to FIG. 9, an example screen view 910 of an instance of the RE is illustrated. The primary function of the RE is to provide graphical and aggregated views of information so that system administrators can assess the system performance and health. The RE works from information in the DS, The RE also provides information into the Management Station as hereinafter described.

Other kinds of reports which the RE can provide include:

(i) Chargeback reports: usually based on a defined group of servers or services. This is a report that contains requests processed, data processed, network efficiency, average SLAs and other information for a group;

(ii) Network utilisation reports;

(iii) Performance of servers/services or groups;

(iv) Request loads over a period of time;

(v) Live graphing of the points above;

(vi) Histogram of the numbers of physical servers required to serve an application throughout a 24 hour or weekly period;

(vii) Specific reports defined as part of the ATTs. In this case ATTs can define reports of their own and an interface to call into for the ME to invoke the report. An example of this would be a business function report for SOAP requests.

The RE largely depends on the ability to perform relational joins and manipulation of raw data in the DS to accomplish the reports required. There are instances where the RE could have to process a great deal of data and in these instances; the RE alerts the user that a request could take a relatively long time to execute.

### 3.8 Proactive Management Unit (PMU)

The PMU is designed to be easily incorporated as an intermediary between distributed applications, without any noticeable impact of adding in the PMU as an intermediary. From an administrator's perspective, to use the PMU, all the administrator need to do is to update the corporations DNS service so that instead of the application endpoint being the end service, the address of the PMU is provided instead.

The PMU has knowledge of all of the ports, applications and DNS names of the applications that are being managed by the overall AMS. This is due to the PMUs close interaction with the DS and the normal service/server and client discovery of the NTE. The PMU starts a TCP/IP listener on all of the ports known by the AMS, Once an application attempts a connection to a service, the application actually establishes a connection to the PMU. Driven by the metadata in the DS, the PMU is then able to proxy the connection to the actual end service, or to balance between different instances of the end service.

The PMU may be inserted into the flow of an application and can provide higher order services. Some of the services the PMU can provide are: reliability (ability to load balance the service across many nodes providing the service); and the ability to retry failures (if the end node came back with a protocol error or timeout, the PMU can send the request to another node.)

The PMU can also accelerate the load by doing dynamic compression on the content as well as heuristics based caching of the content coming through the application. The PMU can also be used to modify and re-format the content on the way through. This is especially relevant for SOAP Web service requests as Web services protocols rely on composition and are already structured as XML (which can be transformed easily).

For example, a specific AMS may have discovered application X which is an application between a client node and a server node, where the client node sends SOAP messages to the server node and receives response messages back. A change to the network environment is made so that when the client node sends SOAP messages to the service, the network address resolved for the service is actually the machine which is running PMU. Due to the AMS's intimate knowledge of application X and the fact that the traffic has now landed on the PMU, the PMU can then intermediate between the client ode, the server node and other server nodes running that service.

### 4. Combined Views

One of the powerful aspects of the AMS is that the individual data from specific ATTs can be merged and filtered through manipulation of the data in the DS. Quite often, the merging of different technologies provides a great insight into system issues and the areas in which investment should be made to improve system responsiveness. As an example, imagine a Web application that has its own relational database to store data and that has an online interface to a mainframe system. The AMS can merge together the Web requests and responses, the database interactions and the interfaces calls to provide the following sort of real-time breakdown of the application:

9:01:31.233 Web request: GetTaxDetails →
9:01:31.745 Database request: GetCustomerInformation →
9:01:31.747 Database response: GetCustomerInformation ←
9:01:31.832 APPC request: RetrieveCustomerTaxProfile →
9:01:31.973 APPC response: RetrieveCustomerTaxProfile ←
9:02:32.078 APPC request: RetrieveLocalTaxRates →
9:02:32.132 APPC request: RetrieveLocalTaxRates ←
9:02:32.643 Database request: StoreCustomerAction →
9:02:32.652 Web response: GetTaxDetails ←
9:02:32.712 Database response: StoreCustomerAction ←

As can be seen from the example above, the AMS detected that the web request to get tax details, resulted in a database request, two mainframe (APPC) transactions and a last database request to log the fact that the request occurred. The AMS allows a system administrator to look at the application and determine that one of the slowest parts of the application is the timing from when the last APPC transaction returned to the time when the Web application was ready to return a response to the end user (half a second).

These combined views can be filtered through specific clients, servers, service and groups. The combined view can also use specific attributes to relate information. For example, the AMS can allow the definition of relationships such as a Web cookie MyAppWorkID) being related to database Table Row (CustomerTable:ID). This allows the filtering of traffic that is relating to a specific conversation. This has uses in determining specific customer issues, timing issues and also turns the AMS into a “black-box” recorder that gives an organisation the ability to perform postmortems on major system issues, fraud attempts etc.

### 5. Traffic Distribution

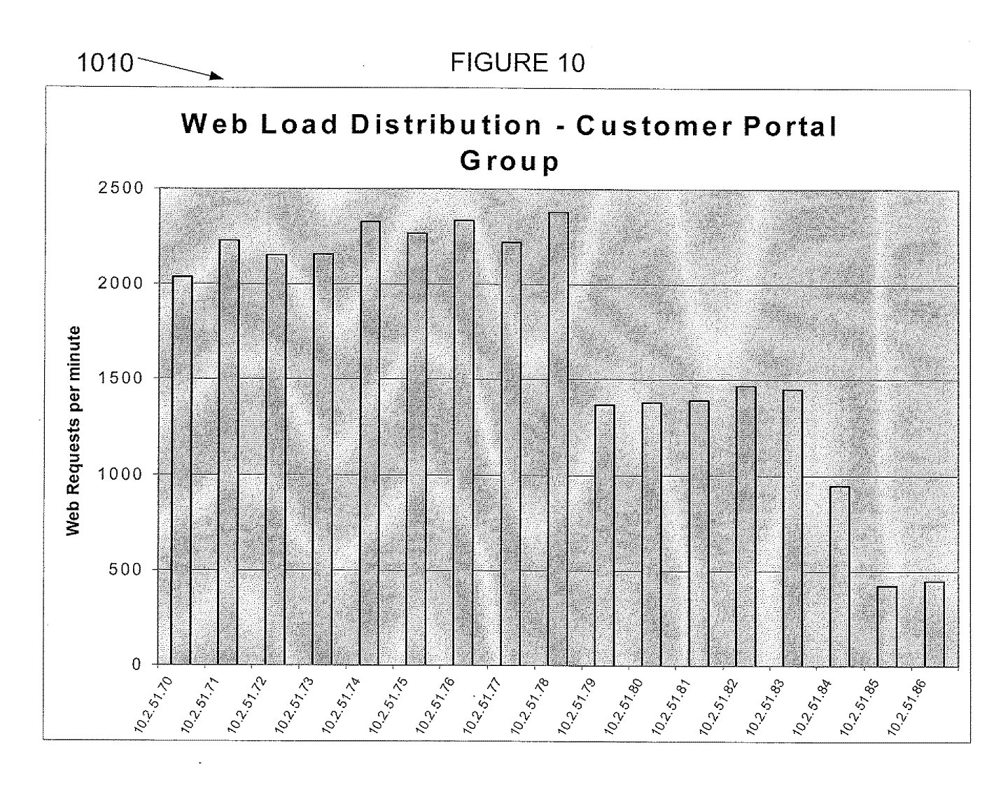

One of the other capabilities the AMS can provide is a traffic distribution of multiple servers (or services) or groups providing the same service. For example, referring to FIG. 10, imagine there are seventeen servers providing the same service, as indicated by the network addresses along the abscissa of the graph 1010. The AMS can create a real time graph 1010 of the transactions being processed by each server for the respective loads. In graph 1010 there is a clear indication to the viewer that there is an issue with the traffic management of the physical machines represented on the right hand side of graph 1010. This traffic distribution can also be filtered by specific customer requests, by transaction type, by database query, etc.

### 6. Passive Management Description

The AMS system initially learns and reports about applications through the act of passively listening on a network. This passive listening on the network looks at the frames propagating on a network link. When the TCP/IP signature of two computers starting to begin an interaction is seen (TCP/IP connection synchronization—SYN-ACK-ACK), the traffic on the connection is interrogated for other attributes (defined in the DS configuration) and is passed on to all or some of the ATTs based on the configuration information.

An example of a possible configuration setting the NTE that can be used to select ATTs could be a TargetPort number. An ATT (X) might have a configuration in the data store that all traffic being sent to a TargetPort of 1521 on a physical computer is sent to ATT (X) for further interrogation. After the connection establishment is completed at the TCP/IP level, the traffic signature can be sampled by some or all ATT's (dependent on the configuration filters) looking for matches.

### 7. Alternative Uses for the Application Management System

The AMS system can be thought of as a platform that new capabilities can leverage and incorporate. Some examples of these alternative uses are provided hereinafter.

### 7.1 Monitoring, Rogue/Disallowed Traffic in a Network

The AMS can be the basis for a system that can diagnose inappropriate or unacceptable interaction in a network, For example, a client workstation in a corporate network that has opened up a port and is accepting requests on that port (i.e. the client workstation is behaving as a server). The AMS's unique capability in this area is that the AMS can diagnose these situations remotely without affecting or changing the workstations in the environment.

### 7.2 Specialised Databases Analysis

The standard database ATTs capture basic information for database interactions in the context of an application. There is the ability to go much deeper into database analysis and provide specialised components this effect.

### 7.3 Network Evaluation Before Allowing Connection to Other Networks

Additionally, the AMS can be used in the scenario where a computer/device attempts to connect into a restricted or corporate network. The AMS can be installed on the remote device and before being allowed to enter the corporate network; the AMS can sample all the traffic in the devices' local network (possibly public network) and provide a summary of the traffic types to the restricted network access control mechanisms of the target network (this includes network traffic not targeted at the device). If software viruses or other malicious software are found on the network the device is connecting from, the restricted network has the option to evaluate and would possibly disallow the connection attempt accordingly.

### 7.4 Specialised Web Analysis Engine

Similar to a specialised database product, it is possible to provide a specialised web analysis tool.

### 7.5 Datacenter Mapping and Navigation

Using the detection capabilities, a product can be provided that generates a schematic of a datacentre and the location of all of the running applications. Such a software product could also recommend changes to the network to improve and optimize the network based on aggregated usage.

### 7.6 Consolidation Assistance Tool

A consolidation assistance tool can be used to provide information to IT professionals to help them decide on how to save costs in a datacentres by consolidating many physical servers onto a smaller set of well managed servers. Many environments suffer from proliferation of servers that are largely idling. The costs of physical servers in a corporate IT department range from about US$10,000-US$100,000 per annum per computer. Consolidating services onto a smaller number of computers reduce IT costs. Presently, consolidation planning is done through time consuming analysis and trial and error. A consolidation assistance tool could automate this process based on the aggregation of the runtime load for the systems in question and could also suggest systems that should be consolidated.

### 7.7 Server Datacenter Power Minimization

The AMS can be used to determine which set of physical computers are serving the same application. The AMS can be configured to reduce the number of servers by concentrating the load on a smaller set of computers. The AMS can send messages to switches/load balancers to concentrate the load on a smaller set of servers. Once the load is more concentrated, the AMS can keep monitoring the service time and incoming rate of requests. The AMS can then decide to further reduce or increase the set of active servers. By reducing the active set, the servers' not processing request load can drop into low power states and save power. This mechanism helps manage the power usage by matching the servers required to the actual load.

### 7.8 Application Quality of Service

By having a deep understanding of an application and the network ports/protocols a specific application uses, the AMS can categorize an application from the perspective of Quality of Service. The AMS can inform the network infrastructure (switches) to prioritize the traffic over the specific ports/protocols being used by an application. This can be done dynamically so that the application's network interactions can be prioritized when compared with the other traffic on the network.

### 7.9 Multiple Route Info

The AMS can be used to detect and optimize all of the routes between two servers or routes involved in client/server interactions. The information can be used to identify the most performant routes (lowest latency routes) between two systems from a network infrastructure perspective.

### 7.10 Test Environment Assistant

Current load testing tools require IT staff to setup the performance tests, transaction mixes and configuration setup when stress testing high volume systems. A test environment assistant product could use a live systems' real load to generate the test tools' input and save test teams significant amounts of time while providing a more accurate test mix.

### 7.11 Software Revision Level Reporting Utility

The ability to automatically report on all of the machines, software included on these computer systems, software release levels and patch levels of devices in a corporate network.

### 7.12 Managed Service Provider Monitoring Station

A specialised management and monitoring product can be provided for managed service providers geared for organisations that are running thousands of websites, databases and outsourced systems, quickly and cost effectively.

### 7.13 Web Service Repository

A Web service repository product can utilise the ability of the AMS to detect all, or at least some of, of the web services in use in an organisation, This could be used to very quickly produce an inventory of web services being used, the versions of the web services in use and a map of dependencies between web service consumers and web service servers. This functionality is of particular interest as enterprises are moving towards Services Oriented architecture but many of these enterprises do not have a management plan. As such, presently web services usage has proliferated without control. The AMS allows an enterprise to re-gain control of one or more deployed web services.

### 7.14 VoIP Enterprise Management

A Voice over IP management and monitoring product can be provided that performs detailed analysis of the Voice over IP usage inside a corporation and considers its impacts with the other different kinds of data traffic running over corporate networks.

The present invention may take the form of an entirely hardware embodiment, an entirely software embodiment, firmware, or an embodiment combining software and hardware aspects.

Thus, there has been provided an application management system, method, and/or computer program product.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although a preferred embodiment has been described in detail, it should be understood that various changes, substitutions, and alterations can be made by one of ordinary skill in the art without departing from the scope of the present invention.

1. An application management system, including:
a network tracking component for obtaining network data;
an application translator, the application translator receiving at least part of the network data, the application translator analyzing the received network data and returning analyzed data; and,
a data store for storing the analyzed data.

2. The application management system as claimed in claim 1, wherein more than one application translator is provided and the application translator is selected from the more than one application translator by the network tracking component.

3. The application management system as claimed in claim 2, wherein the application translator is selected based on a connection instance.

4. The application management system as claimed in claim 2, wherein the selected application translator is retained or not based on the type of further obtained network data.

5. The application management system as claimed in claim 1, wherein the application translator receives the at least part of the network data in a different format to the network data obtained by the network tracking component.

6. The application management system as claimed in claim 5, wherein the different format is generated by a filter component of the application management system.

7. The application management system as claimed in claim 1, wherein the network data is data transmitted between components of at least one distributed application.

8. The application management system as claimed in claim 1, wherein the network data is data transmitted between two or more distributed applications.

9. The application management system as claimed in claim 1, wherein the application management system is not installed on the same processing system as an application.

10. The application management system as claimed in claim 1, wherein the application management system detects network-based applications, services or databases by analyzing the received network data.

11. The application management system as claimed in claim 1, wherein the application management system is associated with at least one network as an inline configuration or as a bus configuration.

12. The application management system as claimed in claim 1, wherein the network data is received as a pre-formatted file.

13. The application management system as claimed in claim 1, wherein there is one instance of the network tracking component for each network interface.

14. The application management system as claimed in claim 1, wherein the data store also stores the obtained network data.

15. The application management system as claimed in claim 1, wherein a proactive management component is provided to receive and forward an application request from a remote terminal.

16. The application management system as claimed in claim 1, wherein a management component is provided and able to communicate with the data store to analyze data stored in data store.

17. The application management system as claimed in claim 16, wherein the management component issues an alert if a preset threshold is exceeded.

18. The application management system as claimed in claim 1, wherein the network data is TCP/IP data.

19. A computer program product for managing one or more applications, including:
a network tracking component for obtaining network data;
an application translator, the application translator receiving at least part of the network data, the application translator analyzing the received network data and returning analyzed data; and,
a data store for storing the analyzed data.

20. An application management system, the application management system installed on at least one processing system and including a tracking unit for monitoring network data received by the at least one processing system, the network data being transmitted between one or more applications, the tracking unit including at least one translator that is called based on a type of data transfer between the one or more applications, wherein the at least one translator analyzes the network data.
